(19) United States
(12) Patent Application Publication
(10) Pub. No.: US 2004/0034710 A1
(43) Pub. Date: Feb. 19, 2004

(54) Data transfer operations

(76) Inventor: Frank Rau, Heilbronn (DE)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/218,847

(22) Filed: Aug. 13, 2002

(51) Int. Cl. G06F 15/16

(52) U.S. Cl. 709/231

(57) ABSTRACT

In one embodiment, a method is provided. In the method of this embodiment, a data stream may be transmitted and/or received. The data stream may include payload and overhead information. The payload may have a variable size. The overhead information may be one type of overhead information selected from a plurality of different types of overhead information. The sequence order of the payload and overhead information may be variable if the type of the overhead information is at least one certain type of overhead information. The method of this embodiment may also include transmitting and/or receiving two characterization parameters. One of these characterization parameters may indicate, at least, the beginning or the end of the overhead information in the first data stream and the type of the overhead information. The other of these characterization parameters may indicate, at least, the beginning or the end of the payload in the first data stream.

### FIELD

This disclosure relates to the field of data transfer operations.

### BACKGROUND

In a data transfer operation according to a conventional data transfer protocol, a data packet or block, containing both header and payload data, in compliance with the protocol, may be exchanged between two or more entities. Typically, the protocol specifies a predetermined maximum amount of payload data that may be contained in the packet or block without violating the protocol.

The protocol also may specify that the entities may exchange information indicating respective maximum amounts of data that the entities are able to accept, without losing data, in such data transfer operations. Typically, the protocol specifies a predetermined sequence order that this information is to have relative to other information in packets or blocks containing such information, and/or a predetermined sequence order in which such packets or blocks are to be exchanged relative to other packets or blocks.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 is a diagram illustrating a system embodiment.

FIG. 2 is a diagram illustrating another system embodiment.

FIG. 3 is a diagram illustrating a data stream according to one embodiment.

FIG. 4 is a diagram illustrating a data stream according to another embodiment.

FIG. 5 is a diagram illustrating a data payload that may be comprised in a data stream according to an embodiment.

FIG. 6 is a diagram illustrating a command that may be comprised in a data stream according to an embodiment.

FIG. 7 is a diagram illustrating an alternate arrangement according to an embodiment.

FIG. 8 is a flowchart illustrating operations that may be performed according to an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

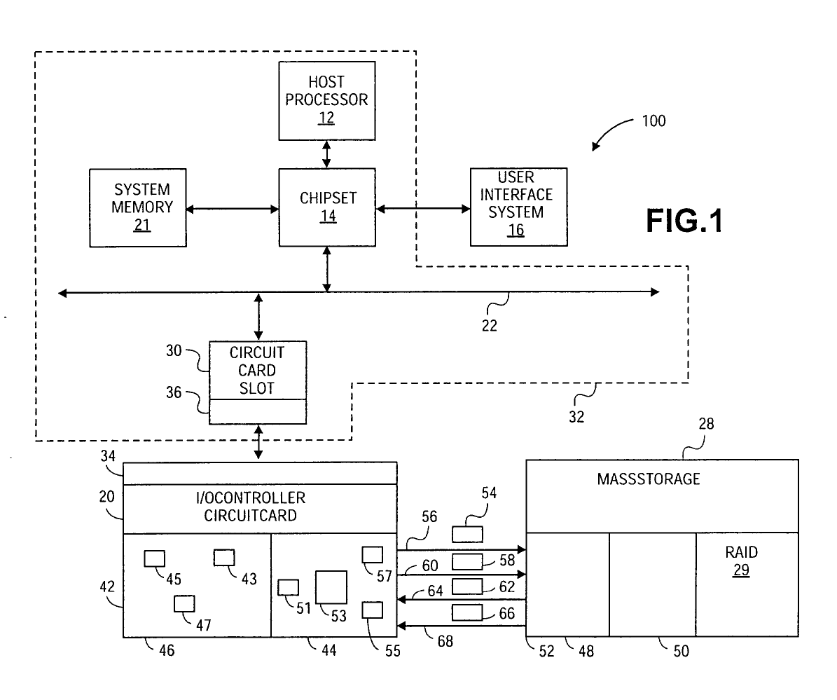

FIG. 1 illustrates a system embodiment 100 of the claimed subject matter. System 100 may include a host processor 12 coupled to a chipset 14. Host processor 12 may comprise, for example, an Intel® Pentium® III or IV microprocessor that is commercially available from the Assignee of the subject application. Of course, alternatively, host processor 12 may comprise another type of microprocessor, such as, for example, a microprocessor that is manufactured and/or commercially available from a source other than the Assignee of the subject application, without departing from this embodiment.

Chipset 14 may comprise a host bridge/hub system that may couple host processor 12, a system memory 21 and a user interface system 16 to each other and to a bus system 22. Chipset 14 may also include an I/O bridge/hub system (not shown) that may couple the host bridge/bus system to bus 22. A “bus” as referred to herein means circuitry to transmit data between or among two or more devices; such circuitry may, for example, comprise one or more communications media through which one or more signals may be propagated between such devices.

Chipset 14 may comprise integrated circuit chips, such as those selected from integrated circuit chipsets commercially available from the assignee of the subject application (e.g., graphics memory and I/O controller hub chipsets), although other integrated circuit chips may also, or alternatively be used, without departing from this embodiment. Additionally, chipset 14 may include an interrupt controller (not shown) that may be coupled, via one or more interrupt signal lines (not shown), to other components, such as, e.g., I/O controller circuit card 20, when card 20 is inserted into circuit card bus extension slot 30. This interrupt controller may process interrupts that it may receive via these interrupt signal lines from the other components in system 100.

The operative circuitry 42 described herein as being comprised in card 20, need not be comprised in card 20, but instead, without departing from this embodiment, may be comprised in other structures, systems, and/or devices that may be, for example, comprised in motherboard 32, coupled to bus 22, and exchange data and/or commands with other components in system 100. User interface system 16 may comprise, e.g., a keyboard, pointing device, and display system that may permit a human user to input commands to, and monitor the operation of, system 100.

Bus 22 may comprise a bus that complies with the Peripheral Component Interconnect (PCI) Local Bus Specification, Revision 2.2, Dec. 18, 1998 available from the PCI Special Interest Group, Portland, Oreg., U.S.A. (hereinafter referred to as a “PCI bus”). Alternatively, bus 22 instead may comprise a bus that complies with the PCI-X Specification Rev. 1.0a, Jul. 24, 2000, available from the aforesaid PCI Special Interest Group, Portland, Oreg., U.S.A. (hereinafter referred to as a “PCI-X bus”). Also alternatively, bus 22 may comprise other types and configurations of bus systems, without departing from this embodiment.

In this embodiment, I/O controller card 20 may comprise a network data communications and/or data storage controller. For example, card 20 may be coupled to and control the operation of a set of one or more magnetic disk, optical disk, solid-state, and/or semiconductor mass storage devices (hereinafter collectively or singly referred to as “mass storage 28”). In this embodiment, mass storage 28 may comprise, for example, among other things, one or more redundant arrays of inexpensive disk (RAID) mass storage devices 29.

RAID-related operations may be carried out by RAID circuitry (not shown) that may be comprised in, e.g., mass storage 28. These RAID-related operations may result in, for example, RAID 29 being implemented in mass storage 28. Alternatively, circuitry 42 may comprise such RAID circuitry. Circuitry 42 may exchange data and/or commands with mass storage 28 that may result in one or more data segments being written to and/or read from RAID 29 in accordance with the RAID technique implemented by RAID 29. Alternatively, host processor 12 may be programmed to emulate operation of such RAID circuitry, and may exchange data and/or commands with mass storage 28 that may result in RAID 29 being implemented in mass storage 28.

Processor 12, system memory 21, chipset 14, PCI bus 22, and circuit card slot 30 may be comprised in a single circuit board, such as, for example, a system motherboard 32. Mass storage 28 may be comprised in one or more respective enclosures that may be separate from the enclosure in which the motherboard 32 and the components comprised in the motherboard 32 are enclosed.

As shown in FIG. 1, I/O controller card 20 may be coupled to mass storage 28 via a plurality of buses that may comprise, for example, buses 56, 60, 64, and 68. More specifically, when card 20 is properly inserted into slot 30, operative circuitry 42 in card 20 may exchange data and/or commands with circuitry 48 in mass storage 28, for example, via buses 56, 60, 64, and 68.

In this embodiment, buses 56, 60, 64, and 68 may comprise respective multi-bit wide, or serialized, uni-directional buses. For example, in this embodiment, buses 60 and 64 may each comprise a respective three-bit wide bus, and buses 56 and 68 may each comprise a respective thirty-two-bit wide bus. Of course, the respective widths and operational characteristics of buses 56, 60, 64, and 68 may vary without departing from this embodiment.

Circuit card slot 30 may comprise a PCI expansion slot that comprises a PCI bus connector 36. Connector 36 may be electrically and mechanically mated with a PCI bus connector 34 that is comprised in circuit card 20. Slot 30 and card 20 are constructed to permit card 20 to be inserted into slot 30. When card 20 is properly inserted into slot 30, connectors 34 and 36 become electrically and mechanically coupled to each other. When connectors 34 and 36 are so coupled to each other, operative circuitry 42 in card 20 becomes electrically coupled to bus 22.

Circuitry 42 may comprise, for example, interface circuitry 44 and control circuitry 46. Mass storage 28 may comprise operative circuitry 48 that may comprise interface circuitry 52 and control circuitry 50. Except as stated to the contrary herein, circuitry 44 and 46 in card 20 may have respective constructions, functions, and/or operations that may be substantially identical to the respective constructions, functions, and/or operations of circuitry 52 and 50 in mass storage 28, with the exception that, circuitry 52 and 50 may be adapted to receive, decode, and/or process streams 54 and 58, and circuitry 52 and 50 also may be adapted to generate, encode, and transmit streams 62 and 66.

Circuitry 44 may generate and transmit to circuitry 52, via buses 56 and 60, data streams 54 and 58, respectively. Circuitry 52 may generate and transmit to circuitry 44, via buses 64 and 68, respectively, data streams 62 and 66. The respective types of information that may be comprised in data stream 58 may be the same as the respective types of information that may be comprised in data stream 62. Additionally, the respective types of information that may be comprised in data stream 54 may be the same as the respective types of information that may be comprised in data stream 66.

Circuitry 44 may comprise transmitter circuitry 57 and receiver circuitry 55. Circuitry 57 may generate and transmit data streams 54 and 58 to circuitry 52 via buses 56 and 60, respectively. Circuitry 55 may receive data streams 62 and 66 transmitted to circuitry 55 from circuitry 52 via buses 64 and 68, respectively. Although not shown in the Figures, circuitry 57 also may include circuitry that synchronizes the transmission of data stream 54 and data stream 58 with a transmission clock signal that is generated by circuitry 44 and supplied to circuitry 52. Additionally, although also not shown in the Figures, circuitry 55 also may include circuitry that synchronizes the reception of data stream 62 and data stream 66 with a reception clock signal that is generated by circuitry 52 and supplied to circuitry 44.

Circuitry 44 may also include encoding logic 53 and decoding logic 51. Encoding logic 53 may receive data and control signals and/or information from direct memory access (DMA) control logic 43 and main control logic 45 comprised in circuitry 46, and based at least in part upon such signals and/or information, logic 53 may generate and supply to circuitry 57 bit streams corresponding to data streams 54 and 58. Decoding logic 51 may receive data streams 62 and 66 from circuitry 55, and based at least in part upon streams 62 and 66, logic 51 may generate and supply to DMA logic 43 and control logic 45 payload data, overhead information, and characterization parameters encoded by data streams 62 and 66.

In addition to comprising DMA logic 43 and main control logic 45, circuitry 46 may also comprise one or more configuration control registers 47. Registers 47 may contain one or more control values that may be set by host processor 12 during one or more configuration cycles in system 100. When set by host processor 12, these control values may result in circuitry 42 operating in and/or undertaking one or more possible operational behaviors that may correspond to such values.

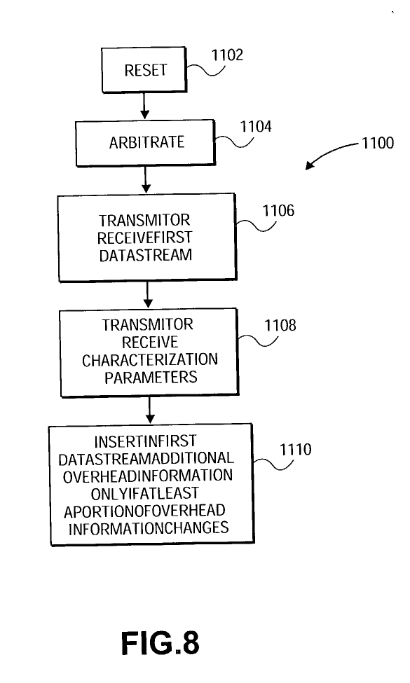

Circuitry 46 may include, for example, a not shown processor that may comprise logic 43, logic 45, and registers 47. Circuitry 46 (e.g., logic 43 and/or logic 45) may exchange data and/or commands with circuitry 44 (e.g., logic 51, logic 53, circuitry 55, and/or circuitry 57) that may permit circuitry 46 to control and/or monitor the operation of circuitry 42. Host processor 12 may exchange data and/or commands with circuitry 46 (e.g., logic 43, logic 45, and/or registers 47), via chipset 14 and bus 22 that may permit host processor 12 to control and/or monitor the operation of circuitry 42. Logic 43 and/or logic 45 may comprise one or more firmware instruction memories that may contain firmware program instructions. These firmware program instructions, when executed, for example, by logic 43 and/or logic 45 may result in, among other things, logic 43 and/or logic 45 issuing appropriate signals to circuitry 44 that may result in execution in system 100 of operations according to one embodiment. FIG. 8 is a flowchart that illustrates these and other operations 1100 that may be carried out in system 100, in accordance with one embodiment.

Operations 1100 may commence with, for example, a reset of system 100, as illustrated by operation 1102 in FIG. 8. As a result of operation 1102, circuitry 44 may signal circuitry 52 via a not shown reset signal line. This may result in circuitry 42 and circuitry 48 entering respective initial modes of operation in which they may arbitrate and/or negotiate with each other, as illustrated by operation 1104, to synchronize, using the transmission clock signal generated by circuitry 44, transmission by circuitry 44 and reception by circuitry 52 of predetermined test data patterns sent via data streams 54 and 58, and to synchronize, using the reception clock signal generated by circuitry 52, transmission by circuitry 52 and reception by circuitry 44 of such test data patterns sent via data streams 62 and 66. When circuitry 44 and 52 determine that such synchronization has been successfully accomplished, they may transmit in data streams 54 and 66 predetermined patterns that may indicate same. After such synchronization has successfully been accomplished, as part of operation 1104, circuitry 44 may transmit to circuitry 52 via bus 54 a predetermined data value that may identify transmission circuitry 57, and circuitry 52 may transmit to circuitry 44 via bus 68 another predetermined data value that may identify its corresponding transmission circuitry (not shown). During operation 1104, data streams 58 and 62 may each comprise only respective, identical predetermined values that may indicate that circuitry 44 and circuitry 52, respectively, are performing respective arbitration and/or negotiation operations and any values propagated via data streams 54 and 66, respectively, are related to such operations.

Thereafter, circuitry 42 and circuitry 48 may exit these respective initial modes of operation and may enter respective other modes of operation in which the contents of the data streams 54, 58, 62, and 66 may be directed to facilitating performance of data transfer operations initiated and/or commanded by host processor 12. That is, when circuitry 42 and 48 are in these other modes of operation, host processor 12 may issue a command to, for example, logic 43 and/or logic 45 in circuitry 42 to read from and/or write data to RAID 29. This may result in logic 43 and/or logic 45 signaling circuitry 44. As is described more fully below, this may result in transmission circuitry 57 generating and transmitting to circuitry 52 in data stream 54 overhead information and/or payload data that may correspond to and/or facilitate initiation of execution by mass storage 28 of the command issued by processor 12, as illustrated by operation 1106. As used herein, overhead information is information that does not comprise idle or payload data, and may command and/or facilitate execution of one or more transfers of payload data. As used herein, idle data may be data that is not considered valid and/or does not correspond to a command, payload data, or other information to facilitate execution of one or more transfers of payload data. As used herein, a characterization parameter may be and/or comprise a value that may characterize and/or identify a type of data and/or information. Also, as will be described more fully below, synchronously with generation and transmission of the overhead information and/or payload data transmitted in data stream 54, transmission circuitry 57 may generate and transmit in data stream 58 one or more characterization parameters that may characterize and/or identify the payload data and/or the type of overhead information transmitted in data stream 54, as illustrated by operation 1108.

Circuitry 48 may receive and decode the overhead information and/or payload data, and in response, at least in part thereto, may generate and transmit to reception circuitry 55 other overhead information and/or payload data in data stream 66 that may acknowledge execution of and/or satisfy the host processor's command. Synchronously with generation and transmission of such other overhead information and/or payload data, circuitry 48 may generate and transmit to reception logic 51 in data stream 62 one or more characterization parameters that may characterize and/or identify the payload data and/or the type of other overhead information transmitted in data stream 66. As part of operations 1106 and 1108, circuitry 42 may receive and decode the payload data and one or more characterization parameters in data streams 62 and 66, and based at least in part thereon, may generate and transmit to host processor 12 data that satisfies the host processor's command and/or an acknowledgement that the host processor's command has been executed by mass storage 28.

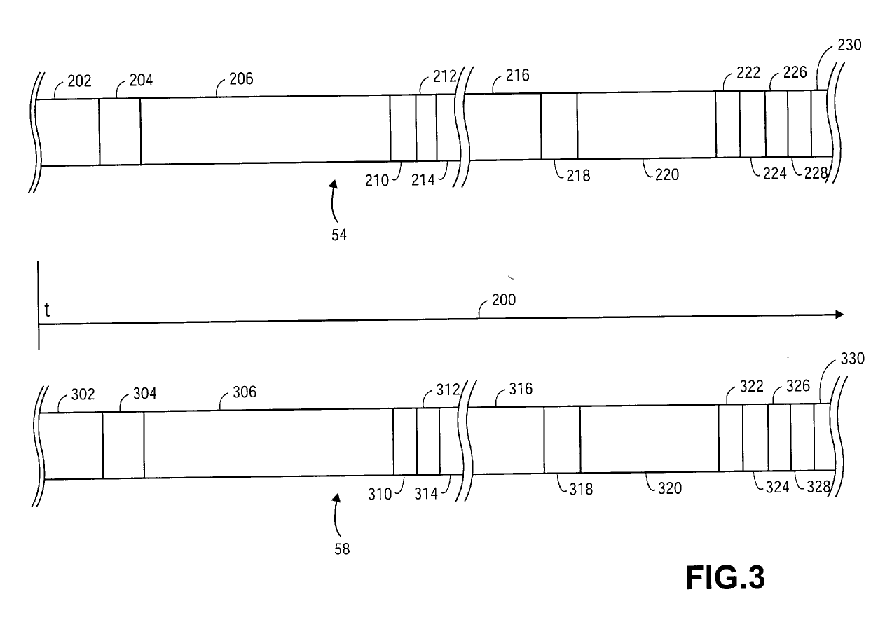

FIG. 3 illustrates an example of payload data and overhead and other information that may be comprised in data stream 54, and example characterization parameters that may be comprised in data stream 58 that may be associated with such data and information. For example, in response to a command to logic 43 and/or logic 45 from host processor 12 to initiate writing of data in RAID 29, logic 43 and/or logic 45 may signal encode logic 53. This may result in encode logic 53 generating and supplying to transmit circuitry 57 both a first sequence of data values that may correspond to the contents of fields 202, 204, and 206 in data stream 54, and a second sequence of data values that may correspond to characterization parameters 302, 304, and 306 in data stream 58. In response to receipt of these first and second sequences of data values by transmission circuitry 57, circuitry 57 may insert into data stream 54 fields 202, 204, and 206 synchronously with the generation and transmission of characterization parameters 302, 304, and 306, respectively, in data stream 58. Thus, for example, in this embodiment, the respective starts and ends of transmission from circuitry 57 of fields 202, 204, and 206 may occur synchronously with the respective starts and ends of transmission from circuitry 57 of characterization parameters 302, 304, and 306, respectively. FIG. 3 illustrates this by showing that the respective starts and ends of fields 202, 204, and 206 occur at respective times along time axis 200 that are synchronous with the respective starts and ends of characterization parameters 302, 304, and 306.

In this example, fields 202 and 204 may contain overhead information, and field 206 may contain payload data related to the write command issued from host processor 12. More specifically, field 202 may contain a write command that may correspond to the write command issued from host processor 12, field 204 may contain error correction and/or detection information (hereinafter collectively or singly referred to as “error correction” information) for the data value contained in field 202, and field 206 may contain one or more pairs of data segments. Such error correction information may comprise, e.g., one or more cyclic redundancy check (CRC) values. These data segments may comprise, for example, payload data and associated error correction information.

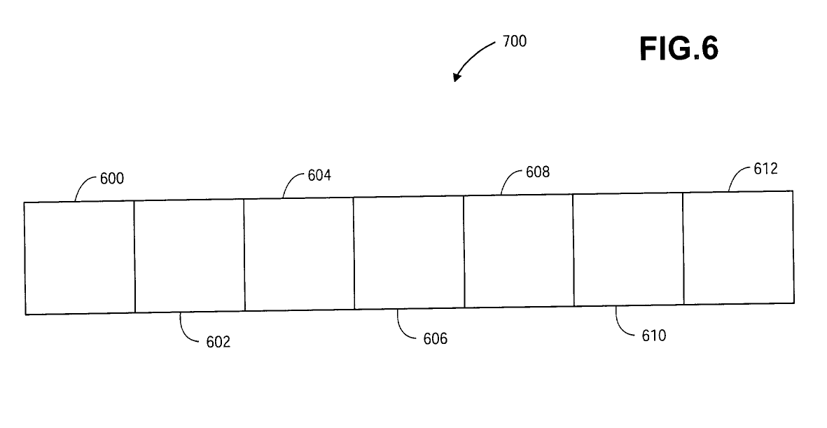

In this embodiment, field 202 may have a structure 700 illustrated in FIG. 6. Structure 700 may comprise sub-fields 600, 602, 604, 606, 608, 610, and 612. Sub-fields 600, 602, 604, 606, 608, 610, and 612 may contain protocol, target identification, command length, originator identification, message identification, command specification, and command sequence information, respectively. Depending upon the particular implementation, sub-fields 600, 602, 604, 606, 608, 610, and 612 each may contain respective multi-byte values, however, in this embodiment, at least fields 600, 604, and 610 may contain respective single byte values. The respective sizes of the data values contained in sub-fields 600, 602, 604, 606, 608, and 610 may be predetermined. The respective size of the data value contained in sub-field 612 may be variable.

The respective value contained in protocol information sub-field 600 may identify the particular data transfer protocol and/or extensions thereof to which data transfer operations between circuitry 42 and 48 in accordance with this embodiment may conform. For example, in this embodiment, the value contained in sub-field 600 may be set to a single predetermined value. However, modifications of data transfer operations in accordance with this embodiment are within the purview of those skilled in the art, and these modifications may be assigned respective values to identify them.

The respective value contained in target identification sub-field 602 may identify the intended receiver of the data stream that contains sub-field 602, in this case, the receiver circuitry in circuitry 48. That is, in this example, the target identification subfield 602 may contain the predetermined data value that was issued from the receiver circuitry of circuitry 48 to identify that receiver circuitry during operation 1104.

In this embodiment, depending upon an addressing mode selected, e.g., by the value of a two-bit sub-field comprised in the value contained in field 602, the particular meaning of the value in the target identification sub-field 602 may vary. For example, in this embodiment, the possible addressing modes that may be selected by this two-bit subfield may include: a normal addressing mode, an extended addressing mode, a group addressing mode, and a further extended addressing mode. In this embodiment, in all but the further extended addressing mode, the value contained in sub-field 602 may be a respective 16-bit value. In the further extended addressing mode, the value contained in sub-field 602 may be a respective 64-bit value.

In the normal addressing mode, each respective bit value in the value contained in target identification sub-field 602 may correspond to a single respective component and/or process in system 100, and in the value in sub-field 602, only a single respective bit value may be set and all other respective bit values in that sub-field 602 may be cleared. By setting a respective bit value in the value in sub-field 602, in the normal addressing mode, the value in sub-field 602 may designate the respective component and/or process that may correspond to the bit value that is set. As used herein, a bit value is considered to be set when it is equal to a value that indicates a first Boolean logical condition (e.g., True), and conversely, a bit value is considered to be cleared when it is equal to a value that indicates a second Boolean logical condition (e.g., False) that is opposite to the first Boolean logical condition.

In the extended and further extended addressing modes, each possible numerical value of the value in target identification sub-field 602 may address a respective component and/or process in system 100. Thus, the maximum number of components and/or processes in system 100 that may be addressed by a value in sub-field 602 in the extended addressing mode may be equal to 65,536, and in the further extended addressing mode, the maximum number of components and/or processes in system 100 that may be addressed by a value in sub-field 602 may be equal to 1.8×10¹⁹.

In the group addressing mode, the value in sub-field 602 may comprise two respective address sub-fields (not shown). One of these respective not shown sub-fields may specify a numerical value that may identify a respective group of components and/or processes in system 100, and the other of these respective not shown sub-fields may specify another numerical value that may identify one or more particular components and/or processes in that group.

The respective value contained in command length sub-field 604 may specify the size, in bytes, of the particular structure 700 that contains sub-field 604, which in this case, may be field 202. The respective value contained in originator identification subfield 606 may identify the transmitter of the data stream that contains sub-field 606, in this case, transmitter circuitry 57. That is, in this example, the originator identification sub-field 606 may contain the predetermined data value that was issued from circuitry 57 to identify circuitry 57 during operation 1104. The value contained in sub-field 606 may be in accordance with, and may have a meaning in accordance with the particular addressing mode (e.g., normal, extended, group, or further extended addressing mode) selected by the value of a two-bit sub-field comprised in the value contained sub-field 606, e.g., in accordance with the corresponding meanings that may be assigned, in the manner described above, to the value that may be contained in target identification subfield 602.

The respective value contained in message identification sub-field 608 may contain a value that identifies the sequence order of transmission of the particular structure 700 that contains sub-field 608, in this case, field 202, relative to any other such structures 700 transmitted between circuitry 42 and circuitry 48 after completion of operation 1104. For example, in this embodiment, if field 202 is the first such structure 700 to be transmitted between circuitry 42 and circuitry 48 after completion of operation 1104, sub-field 608 may contain a value of 0 hexadecimal (hex). Conversely, if field 202 is the second such structure 700 to be transmitted between circuitry 42 and circuitry 48 after completion of operation 1104, sub-field 608 may contain a value of 1 hex, and so forth, depending upon the particular sequence order of field 202 relative to any other structures 700 transmitted between circuitry 42 and circuitry 48 after completion of operation 1104.

The respective value contained in command specification field 610 may identify the particular type of message being issued as a result of transmission of the particular structure 700 that contains the particular field 610. For example, in this embodiment, there may be four possible messages that may be issued using structure 700: a read command (e.g., to request that mass storage 28 read specified data), a write command (e.g., to request, as in this example, that mass storage 28 write specified data), an acknowledgement message (e.g., that may indicate and/or contain status information that may indicate the status (e.g., success or failure) of a previously executed write or read command), and a special message (e.g., that may indicate and/or contain other types of status information and/or commands, such as, for example, information that may indicate whether mass storage 28 and/or RAID 29 are functioning properly). Each of these possible messages may be assigned a respective identification value that, depending upon the particular type of message being issued as a result of transmission of the particular structure 700, may be contained in field 610 of that structure 700, in order to appropriately identify that structure 700 as issuing that particular type of message.

Command sequence field 612 may contain a plurality of values that may serve as arguments to the message being issued as a result of the transmission of the structure 700 that contains field 612. For example, if the value contained in field 610 of a particular structure 700 indicates that a read command is being issued using that structure 700, field 612 may contain a sequence of four values. The first of the four values may be reserved for future use. The second of the four values may be a numerical value that specifies the size, in bytes, of the data to be read as a result of execution of the read command. The third of the four values may be a destination address of the data to be read as a result of the execution of the read command. The fourth of the four values may be a source address of the data to be read as a result of the execution of the read command.

The destination and source addresses specified by the third and fourth values, respectively, may specify, e.g., one or more destination components and/or processes and one or more source components and/or processes, respectively, in system 100 of the data to be read as a result of the execution of the read command. The destination and source addresses specified by the third and fourth values, respectively, may comprise, e.g., 32-bit or 64-bit memory mapped I/O addresses that may comply with addressing conventions used in assigning, e.g., memory mapped I/O addresses of PCI or PCI-X buses.

Conversely, if, as is the case in this example, the value contained in field 610 of a particular structure 700 indicates that a write command is being issued using that structure 700, field 612 may contain a sequence of three values. The first of the three values may be reserved for fuiture use. The second of the three values may be a numerical value that specifies the size, in bytes, of the data (e.g., the payload data contained in field 206) to be written as a result of execution of the write command. The third of the three values may be a destination address of the data to be written as a result of the execution of the write command.

If the value contained in field 610 of a particular structure 700 indicates that an acknowledgement message is being issued using that structure 700, field 612 may contain a sequence of two values. The first of the two values may be a 16-bit numerical value that may indicate and/or contain status information that may indicate the status (e.g., success or failure) of a previously executed write or read command. The second of the two values may be equal to the value that was contained in the message identification sub-field 608 of the structure 700 that whose transmission resulted in the execution of the previous write or read command.

If the value contained in field 610 of a particular structure 700 indicates that a special message is being issued using that structure 700, field 612 may contain a sequence of two values. The first of the two values may be a 16-bit numerical value that may be reserved for future use. The second of the two values may be a variable-length numerical value that may indicate and/or contain other types of status information and/or commands (e.g., information that may indicate whether mass storage 28 and/or RAID 29 are functioning properly). This variable length value may have a maximum size of, for example, 128 bits.

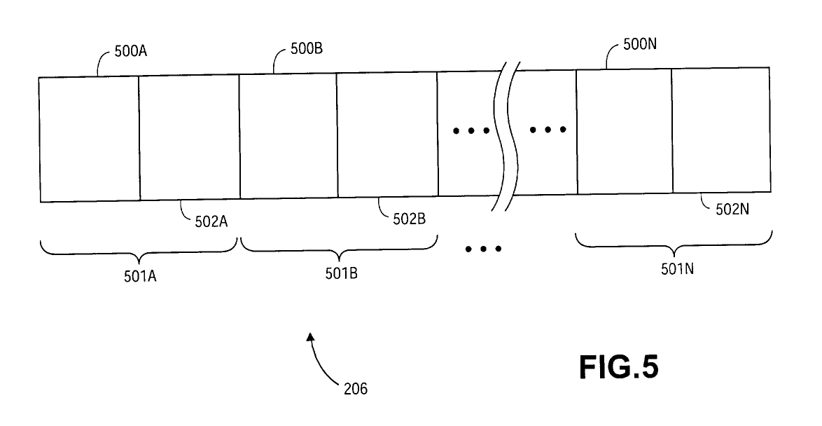

Each data payload field in streams 54 and 66 may comprise one or more respective pairs of contiguous data segments. Each of these pairs of data segments may comprise a respective data payload segment and a respective error correction segment. For example, as shown in FIG. 5, data payload 206 may comprise a plurality of contiguous pairs 501A, 501B, . . . 501N of contiguous data segments. Each of these pairs 501A, 501B, . . . 501N of contiguous data segments may comprise a respective data payload segment and a contiguous respective error correction segment that may contain error correction information for correcting and/or detecting errors that may be contained the respective data payload segment. For example, pair 501A may comprise data payload segment 500A and contiguous error correction segment 502A that may contain error correction information that may be used to correct and/or detect errors that may be contained in segment 500A, pair 501B may comprise data payload segment 500B and contiguous error correction segment 502B that may contain error correction information that may be used to correct and/or detect errors that may be contained segment in 500B, and pair 501N may comprise data payload segment 500N and contiguous error correction segment 502N that may contain error correction information that be used to correct and/or detect errors that may be contained in segment 500N. In this embodiment, each of the data payload segments 500A, 500B, . . . 500N may have a maximum size of, for example, 2084 bytes. In this embodiment, each of the error correction and/or detection segments 502A, 502B, . . . 502N may contain respective 4-byte error correction information values that may be used to correction and/or detect one or more errors that may be present and/or injected into the data payload segments 500A, 500B, . . . 500N during and/or as a result of transmission in data stream 54.

Characterization parameters 302 and 304 may have respective values that may identify and/or characterize the contents of fields 202 and 204 as comprising a command/message and error correction information, respectively. Characterization parameter 306 may have a value that may identify and/or characterize the contents of fields 206 as comprising data payload and associated error correction information. Parameter 306 may replaced with a plurality of characterization parameters that may be respectively transmitted from circuitry 42 synchronously with, and may respectively separately identify and/or characterize the data payload segments 500A, 500B, . . . 500N in field 206 as containing payload data, and each of the error correction segments 502A, 502B, . . . 502N as containing error correction information.

In this embodiment, there is no pre-set or predetermined maximum number of respective pairs of such data segments that may be comprised in any respective data payload field in streams 54 and 66. Thus, for example, there is no pre-set or predetermined maximum number of respective pairs 501A, 501B, . . . 501N that may be comprised in data payload field 206, and the respective amounts of payload data in any such payload field may be variable. Thus, advantageously, in this embodiment, there is no predetermined maximum amount of payload data that may be contained in a respective data payload field in streams 54 and 66, such as, for example, field 206 in stream 54. Also advantageously, in this embodiment, regardless of the amount of payload data contained in field 206 to be written in mass storage 28, circuitry 42 may issue only a single structure 700 (such as, in this example, field 202) and a single error correction field (such as, in this example, field 204) associated with that structure 700 to issue the command to write the payload data in mass storage 28.

After transmitting fields 202, 204 and 206 in stream 54, and transmitting characterization parameters 302, 304, and 306 in stream 58, respectively, logic 43 and/or logic 45 may signal encode logic 53 to generate and transmit in stream 54 idle data. This may result in encode logic 53 generating and transmitting to transmitter circuitry 57 respective data values that may correspond to such idle data and a characterization parameter that may identify such idle data. In response to receipt of such data values from encode logic 53, circuitry 57 may transmit idle data 210 in stream 54, and synchronously therewith, circuitry 57 may transmit a characterization parameter 310 in stream 58 that may have a value that may identify idle data 210 as being constituting idle data. In this embodiment, the respective starts and ends of transmission from circuitry 57 of idle data 210 may occur synchronously with the respective starts and ends of transmission from circuitry 57 of characterization parameter 310.

Thereafter, logic 43 and/or logic 45 may continue to signal encode logic 53 to generate and transmit in stream 54 idle data until such time as logic 43 and/or logic 45 signals encode logic 53 to insert in stream 54 additional overhead information that may change at least a portion of the overhead information previously transmitted in stream 54. In this embodiment, logic 43 and/or logic 45 may signal encode logic 53 to insert such additional overhead information in stream 54 only if it is desired to change at least a portion of the overhead information previously transmitted in stream 54, as illustrated in operation 1110 in FIG. 8. For example, prior to transmission of field 202 in stream 54, circuitry 42 may have transmitted to circuitry 48 in stream 54 data flow control information. Such data flow control information may comprise, e.g., receive buffer credit information (not shown) that may indicate, e.g., an amount of receive buffer memory (not shown) in circuitry 55 that may be available to receive data propagated to circuitry 55 via bus 68. That is, as non-idle data (e.g., payload data and overhead information) is received by circuitry 55 from stream 66, a receive buffer memory (not shown) that may be comprised in circuitry 55 may fill with such non-idle data. As this memory fills, circuitry 55 may signal logic 45 and/or logic 43. In response to such signaling, logic 45 and/or logic 43 may signal encode logic 53 and/or transmitter circuitry 57 to propagate to circuitry 48 in stream 54 via bus 56 overhead information (e.g., data flow control information) that may indicate, e.g., the amount of this receive buffer memory in circuitry 55 that may remain available to receive such non-idle data propagated to circuitry 55 via stream 66. In response, encode logic 53 may signal circuitry 57 and/or circuitry 57 may insert into data stream 54 such data flow control information, and circuitry 57 may also insert into data stream 58, synchronously with insertion of the data flow control information into stream 54, a characterization parameter that may identify the type of overhead information inserted into stream 54, as being data flow control information. In response to receipt of this data flow control information and characterization parameter, circuitry 48 may adjust, as appropriate, the amount of non-idle data being propagated to circuitry 55 per unit time so as to avoid overfilling the receive buffer memory.

Thereafter, if the amount of receive buffer memory in circuitry 55 that is available to receive non-idle data from circuitry 48 changes, logic 45 and/or 43 may signal circuitry 57 and/or logic 53 to change and/or update the data flow control information previously provided to circuitry 48. In response, encode logic 53 may signal circuitry 57 and/or circuitry 57 may insert into data stream 54 additional data flow control information 212, and circuitry 57 may also insert into data stream 58, synchronously with insertion of data flow control information 212 into stream 54, a characterization parameter 312 that may identify data flow control information 212 as data flow control information. Thereafter, assuming that circuitry 42 has not yet received any additional command to read data from, or to write data to mass storage 28, logic 45 and/or logic 43 may signal logic 53 to insert into stream 54 additional idle data. This may result in additional idle data 214 being inserted by circuitry 57 into stream 54 synchronously with insertion of characterization parameter 314 into stream 58 by circuitry 57, in the manner described previously.

The sequence order of at least data flow control information 212 relative to fields 202, 204, 206, 210, etc. in data stream 54 may be variable. Thus, for example, although not shown in the Figures, if the amount of receive buffer memory in circuitry 55 available to receive data propagated to circuitry 55 via buses 64 and 68 changes prior to transmission of field 202, data flow control information 212 may be transmitted by circuitry 57 prior to transmission of field 202, without departing from this embodiment. Of course, the sequence order of other types of overhead information (i.e., other than data flow control information) also may be variable without departing from this embodiment.

After idle data 214 has been inserted into stream 54, circuitry 42 may receive, for example, two commands from host processor 12 to read data from RAID 29. This may result in circuitry 42 generating and transmitting, in the manner described previously, command fields 216 and 220 that may each comprise a respective structure 700 that, when received by circuitry 48, may result in circuitry 48 initiating the execution by mass storage 28 of a respective one of these two read commands from host processor 12. Fields 216 and 220 may be associated with error correction fields 218 and 222, respectively, that may contain respective error correction information that may be used by circuitry 48 to detect and/or correct one or more errors that may be introduced into the contents of field 216 and/or 220, during, for example, propagation of such contents to circuitry 48 via bus 56. Circuitry 57 may also propagate via bus 60, synchronously with propagation of the contents of fields 216, 218, 220, and 222 via bus 56, characterization parameters 316, 318, 320, and 322 that may have respective values that may identify fields 216, 218, 220, and 222 as containing a read command, error correction information, another read command, and additional error correction information, respectively. Thereafter, in this example, circuitry 42 may insert into stream 54, in the manner described previously, fields 224, 226, 228, and 230 which may contain idle data, additional data flow control information, idle data, and additional data flow control information, respectively. Synchronously with transmission of the contents of fields 224, 226, 228, and 230, circuitry 42 may insert into stream 58, in the manner described previously, characterization parameters 324, 326, 328, and 330. Parameters 324, 326, 328, and 330 may have respective values that may identify the respective contents of fields 224, 226, 228, and 230 as idle data, additional data flow control information, idle data, and additional data flow control information.

Thus, in this example, the types of overhead information that may be in streams 54 and/or 66 may include, for example, command/message information, error correction information, and flow control information. Each of these types of overhead information may be associated with and/or identified by a respective corresponding characterization parameter. Also, in this example, payload data and associated error correction information, as well as, idle data may be associated with and/or identified by a respective corresponding characterization parameter.

In this embodiment, the transmission of the respective beginnings and ends of the contents of fields 202, 204, 206, 210, 212, 214, 216, 218, 220, 222, 224, 226, 228, and 230 may occur synchronously with the transmission of the respective beginnings and ends of characterization parameters 302, 304, 306, 310, 312, 314, 316, 318, 320, 322, 324, 326, 328, and 330, respectively. Additionally, the respective beginnings and ends of fields 202, 204, 206, 210, 212, 214, 216, 218, 220, 222, 224, 226, 228, and 230 may be received by circuitry 48 synchronously with the receipt by circuitry 48 of the respective beginnings and ends of characterization parameters 302, 304, 306, 310, 312, 314, 316, 318, 320, 322, 324, 326, 328, and 330, respectively. Thus, receipt by circuitry 48 of characterization parameters 302, 304, 306, 310, 312, 314, 316, 318, 320, 322, 324, 326, 328, and 330 may be used by circuitry 48 to indicate either, or both of, each of the respective beginnings and/or the respective ends of transmission of the contents of fields 202, 204, 206, 210, 212, 214, 216, 218, 220, 222, 224, 226, 228, and 230, respectively. As circuitry 48 receives characterization parameters 302, 304, 306, 310, 312, 314, 316, 318, 320, 322, 324, 326, 328, and 330, circuitry 48 may examine decode, based upon their respective values, the respective types of data (e.g., payload data and associated error correction information and/or idle data) and/or overhead information (e.g., command/message, error correction, and/or data flow control information) that may be identified by them. Circuitry 48 may associate these respective types of data and/or overhead information, identified by characterization parameters 302, 304, 306, 310, 312, 314, 316, 318, 320, 322, 324, 326, 328, and 330, with fields 202, 204, 206, 210, 212, 214, 216, 218, 220, 222, 224, 226, 228, and 230, respectively, received synchronously with 302, 304, 306, 310, 312, 314, 316, 318, 320, 322, 324, 326, 328, and 330, in order to appropriately decode the contents of fields 202, 204, 206, 210, 212, 214, 216, 218, 220, 222, 224, 226, 228, and 230 in accordance with the respective types of data and/or overhead information that they may contain.

For example, in response to receipt of the contents of field 216 and characterization parameter 316, circuitry 48 may examine parameter 316 and may determine therefrom that field 216 contains a command/message type of overhead information. Circuitry 48 may then parse and examine the contents of the various sub-fields comprised in the structure 700 contained in field 216, and based at least in part thereon, circuitry 48 may determine the read command encoded in field 216. This may result in circuitry 48 transmitting to circuitry 42 via stream 66 fields that may contain a write command having structure 700, payload data, and associated error correction information, and synchronously therewith, transmitting in stream 62 characterization parameters that may respectively identify the contents of such fields. The field that contains the write command may contain a sub-field that specifies a destination address to which the payload data is to be written. This destination address may correspond to an address (e.g., source or destination address) specified in the read command.

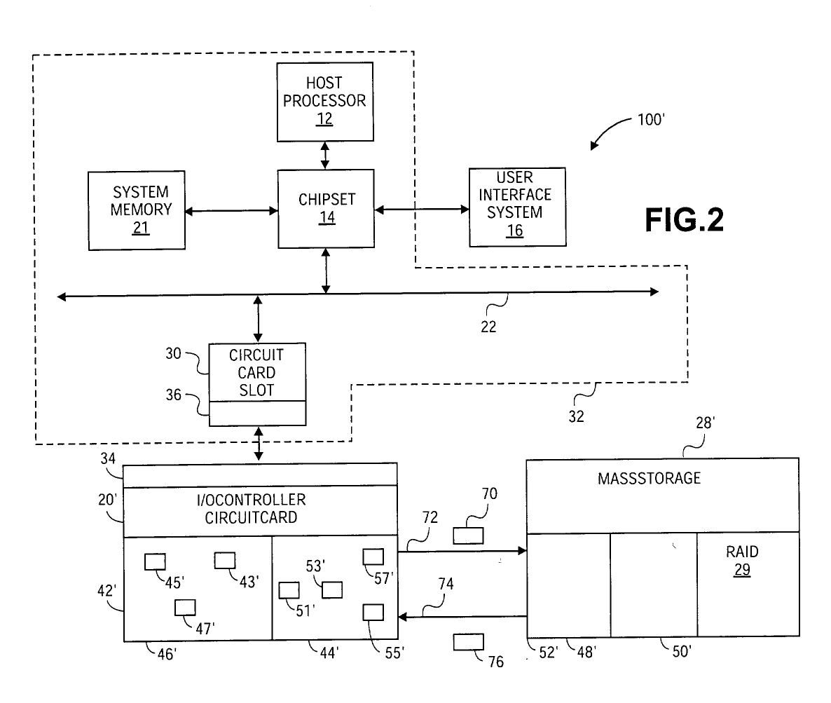

With reference now being made to FIG. 2, another system embodiment 100′ will be described. In addition to components 12, 14, 16, 21, 22, 29, 30, 32, 34, and 36 in system 100′ that may be respectively identical to their like-numbered counterparts in system 100, system 100′may also include I/O controller card 20′ and mass storage 28′. Card 20′ may include operative circuitry 42′ that may include interface circuitry 44′ and control circuitry 46′. Mass storage 28′ may include operative circuitry 48′ that may include interface circuitry 52′ and control circuitry 50′. Interface circuitry 44′may include transmitter circuitry 57′, receiver circuitry 55′, encode logic 53, and decode logic 51′. Control logic 46′ may include DMA control logic 43, main control logic 45, and control registers 47′. System 100′ also may include uni-directional bus 72 that may couple circuitry transmitter circuitry 57′ to circuitry 52′, and uni-directional bus 74 that may couple circuitry 52′ to receiver circuitry 74.

Except as stated to the contrary herein, the respective constructions, functions, and operations of card 20′, mass storage 28′, circuitry 42′, logic 43′, circuitry 44′, logic 45′, circuitry 46′, registers 47′, circuitry 48′, circuitry 50′, logic 51′, circuitry 52′, logic 53′, circuitry 55′, and circuitry 57′in system 100′may be substantially similar to the respective constructions, functions and operations of card 20, mass storage 28, circuitry 42, logic 43, circuitry 44, logic 45, circuitry 46, registers 47, circuitry 48, circuitry 50, logic 51, circuitry 52, logic 53, circuitry 55, and circuitry 57 in system 100. However, in system 100′, in order to initiate and/or facilitate data transfer operations between mass storage 28′ and circuitry 42′, circuitry 42′ and circuitry 48′ may exchange two data streams 70 and 76 via buses 72 and 74, respectively, instead of the four data streams 54, 58, 62, and 66 that may be exchanged between circuitry 44 and 52 via buses 56, 60, 64, and 68, respectively, in system 100. Accordingly, circuitry 42′ (and/or components thereof, such as, for example, circuitry 46′ , circuitry 44′, logic 43′, logic 45′, registers 47′, logic 51′, logic 53′, transmitter circuitry 57′, and/or receiver circuitry 55′) and circuitry 48′ (and/or components thereof, such as, for example, circuitry 52′ and/or circuitry 50′) may be adapted to permit data streams 70 and 76 to be so exchanged. Additionally, circuitry 42′, and/or components thereof, may be adapted to encode and transmit, via bus 72, data stream 70 to circuitry 48′, and to receive data stream 76 from circuitry 48′, via bus 74, and to decode the received data stream 76. Circuitry 48′, and/or components thereof, may be adapted to encode and transmit, via bus 74, data stream 76 to circuitry 42′, and to receive data stream 70 from circuitry 42′, via bus 72, and to decode the received data stream 70. Buses 72 and 74 may comprise respective multi-bit wide, or serialized, uni-directional buses.

Depending upon the specific contents of data streams 70 and 76 at any given time, the specific contents of data streams 70 and 76, respectively, may differ from each other. However, the respective types of information that may be comprised in data stream 70 may be the same as the respective types of information that may be comprised in data stream 76.

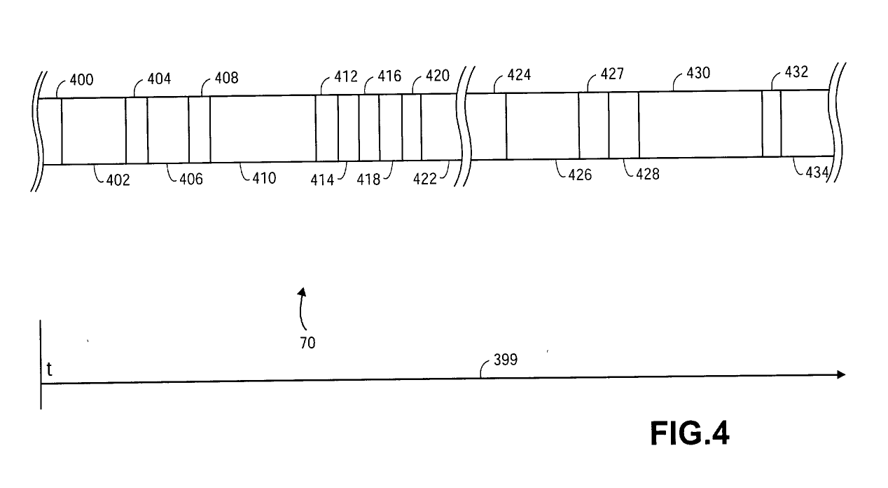

As shown in FIG. 4, data stream 70 may comprise a plurality of fields, such as, for example, fields 400, 402, 404, 406, 408, 410, 412, 414, 416, 418, 420, 422, 424, 426, 427, 428, 430, 432, and 434. The contents of fields 402, 406, 410, 414, 418, 422, 424, 427, 430, and 434 in stream 70 may be substantially identical to the contents of, for example, fields 202, 204, 206, 210, 212, 214, 216, 218, 220, and 222, respectively. Fields 400, 404, 408, 412, 416, 420, 426, 428, and 432 each may contain, for example, a respective characterization parameter that may identify and/or characterize the respective contents of the respective closest preceding field (i.e., the respective field that was most recently transmitted in stream 70 prior to transmission of the respective characterization parameter, as indicated by time axis 399). Thus, for example, the characterization parameters in fields 404, 408, 412, 416, 420, 426, 428, and 432 may identify and/or characterize the respective contents of fields 402, 406, 410, 414, 418, 422, 424, 427, and 430, respectively. Each of the respective characterization parameters contained in fields 400, 404, 408, 412, 416, 420, 426, 428, and 432 also may identify, delimit, and/or indicate the respective end of the respective closest preceding field in steam 70, and may identify, delimit, and/or indicate the respective beginning of the respective closest subsequent field in stream 70. Thus, for example, the characterization parameters in fields 404, 408, 412, 416, 420, 426, 428, and 432 may identify, delimit, and/or indicate the respective ends of fields 402, 406, 410, 414, 418, 422, 424, 427, and 430, respectively. Characterization parameters 404, 408, 412, 416, 420, 426, 428, and 432 also may identify, delimit, and/or indicate the respective beginnings of fields 406, 410, 414, 418, 422, 424, 427, 430, and 434, respectively.

In system 100′, the characterization parameters in fields 400, 404, 408, 412, 416, 420, 426, 428, and 432 may be encoded with values corresponding to, for example, predetermined 8 bit/10 bit encoding special Kxx.x characters of the type that may be used in, e.g., Fibre Channel protocol compliant or compatible with the interface/protocol described in ANSI Standard Fibre Channel (FC) Physical and Signaling Interface-3X3.303:1998 Specification. For example, characterization parameters identifying and/or characterizing data flow control information, payload data, idle data, command/message information, and error correction information may have values corresponding to characters K30.7, K27.7, K28.0, K28.2, and K29.7, respectively. Additionally, in system 100′, the predetermined value that may be transmitted to indicate transmission of arbitration information, e.g., during and/or as a result of performance of operation 1104 in FIG. 8, may correspond to character K23.7.

Alternatively, without departing from system embodiment 100′, in stream 70, the respective orders of the respective characterization parameters and the respective fields characterized and/or identified by the respective characterization parameters may be reversed. In this alternative arrangement, in stream 70, each respective characterization parameter may identify and/or characterize the respective contents of the respective closest subsequent field (i.e., the respective field that is next transmitted in stream 70 after transmission of the respective characterization parameter, as indicated by time axis 399).

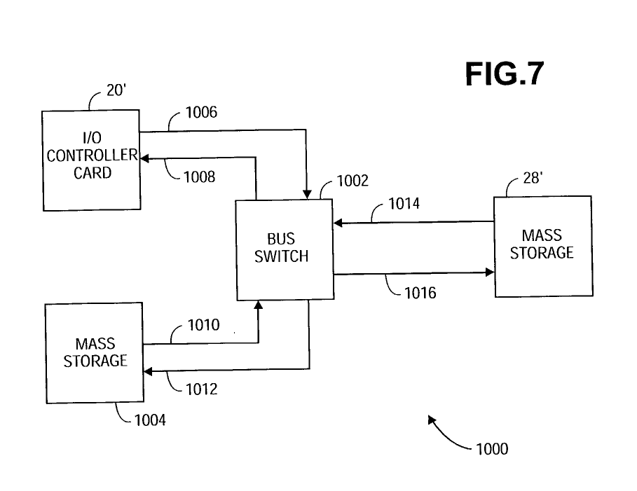

FIG. 7 illustrates another system embodiment 1000. In system 1000, the respective the components comprised in motherboard 32′ are not shown, however, it should be appreciated that card 20′ may be coupled to slot 30. In system 1000, the respective construction, functions, and operations of mass storage 1004 may be substantially identical to those of mass storage 28′.

As shown in FIG. 7, card 20′, mass storage 28′, and mass storage 1004 may be coupled to bus switch 1002 via respective pairs of multi-bit wide, or serialized, uni-directional buses. More specifically, card 20′ may be coupled to switch 1002 via buses 1006 and 1008, mass storage 28′ may be coupled to switch 1002 via buses 1014 and 1016, and mass storage 1004 may be coupled to switch 1002 via buses 1010 and 1012, respectively. Except as stated to the contrary herein, the respective constructions, functions, and operations of buses 1006 and 1008 may be respectively substantially identical to buses 72 and 74, the respective constructions, functions, and operations of buses 1010 and 1012 may be respectively substantially identical to buses 72 and 74, and the respective constructions, functions, and operations of buses 1014 and 1016 may be respectively substantially identical to buses 72 and 74. Switch 1002 may be able to decode the information contained in data streams that may be exchanged with switch 1002 via buses 1006, 1008, 1010, 1012, 1014, and 1016. During operation 1104, switch 1002 may use conventional techniques to “learn” the respective predetermined identification numbers associated with the respective transmitter circuitry (not shown) in card 20′, mass storage 28′, and mass storage 1004. In system 1000, all command/message information may contain respective target identification information.

Thereafter, during, e.g., operations 1106, 1108, and/or 1110 (see FIG. 8), switch 1002 may parse, decode, temporarily store, and forward via buses 1008, 1012, and/or 1016 appropriate respective portions of the respective contents of respective fields in the data streams that switch 1002 may receive via buses 1006, 1010, and/or 1014. Switch 1002 may perform these forwarding operations, based at least in part, upon received target identification information from decoded command/message information received by switch 1002, and in such a way as to ensure that portions of the streams received by switch 1002 that may represent discrete command/message information and associated payload data, if any, are forwarded to the recipient identified by associated target identification information in a manner that maintains the coherency of such discrete information and associated payload data. Switch 1002 may reformat such discrete command/message information and/or associated payload data and/or insert idle data and/or appropriate characterization parameters into the steams that it may transmit via buses 1008, 1012, and/or 1016 in order to maintain the coherency of such discrete command/message information and associated payload data.

Thus, in summary, one system embodiment may include a circuit board including a bus, and a circuit card capable of being coupled to the bus. The circuit card also may include first circuitry capable of at least one of transmitting and receiving one or more data streams. The first circuitry may be capable of transmitting and receiving a plurality of data streams. The plurality of data streams may include a first data stream that may include payload and overhead information. The payload may have a variable size, and the overhead information may be one type of overhead information selected from a plurality of different types of overhead information. The sequence order of the payload and the overhead information may be variable if the one type is at least one certain type of overhead information selected from the plurality of different types of overhead information. The first circuitry also may be capable of at least one of transmitting and receiving a plurality of characterization parameters. The plurality of characterization parameters may include one characterization parameter indicating, at least, one of a beginning and an end of the overhead information in the first data stream and the one type of the overhead information. The plurality of characterization parameters also may include another characterization parameter indicating, at least, one of a beginning and an end of the payload in the first data stream.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. A method comprising:
one of transmitting and receiving a first data stream, the first data stream including payload and overhead information, the payload having a variable size, the overhead information being one type of overhead information selected from a plurality of different types of overhead information, sequence order of the payload and the overhead information being variable if the one type is at least one certain type of overhead information selected from the plurality of different types of overhead information;
one of transmitting and receiving two characterization parameters, one of the characterization parameters indicating, at least, one of a beginning and an end of the overhead information in the first data stream and the one type of the overhead information, the other of the characterization parameters indicating, at least, one of a beginning and an end of the payload in the first data stream.

2. The method of claim 1, further comprising:
one of transmitting and receiving a second data stream that is different from the first data stream, the second data stream comprising the two characterization parameters.

3. The method of claim 2, further comprising:
propagating the first data stream via a first bus; and
propagating the second data stream via a second bus.

4. The method of claim 3, wherein:
the one of the characterization parameters is one of transmitted synchronously and received synchronously with the one of the beginning and the end of the overhead information; and
the other of the characterization parameters is one of transmitted synchronously and received synchronously with the one of the beginning and the end of the payload.

5. The method of claim 1, wherein:
the plurality of different types of overhead information comprises data flow control information related to a second data stream different from the first data stream.

6. The method of claim 1, wherein:
the first data stream comprises the two characterization parameters;
the one of the characterization parameters and the one of the start and the end of the overhead information are contiguous with each other in the first data stream; and
the other of the characterization parameters and the one of the start and the end of the payload are contiguous with each other in the first data stream.

7. The method of claim 1, wherein:
the overhead information of the one type includes data transfer control information; and
the method further comprises inserting in the first data stream additional overhead information of the one type only if at least a portion of the control information changes.

8. An apparatus comprising:
circuitry capable of one of transmitting and receiving a first data stream, the first data stream including payload and overhead information, the payload having a variable size, the overhead information being one type of overhead information selected from a plurality of different types of overhead information, sequence order of the payload and the overhead information being variable if the one type is at least one certain type of overhead information selected from the plurality of different types of overhead information, the circuitry also being capable of one of transmitting and receiving two characterization parameters, one of the characterization parameters indicating, at least, one of a beginning and an end of the overhead information in the first data stream and the one type of the overhead information, the other of the characterization parameters indicating, at least, one of a beginning and an end of the payload in the first data stream.

9. The apparatus of claim 8, wherein:
the circuitry is also capable of one of transmitting and receiving a second data stream that is different from the first data stream, the second data stream comprising the two characterization parameters.

10. The apparatus of claim 9, wherein:
the circuitry is also capable of being coupled both to a first bus to propagate the first data stream and to a second bus to propagate the second data stream.

11. The apparatus of claim 10, wherein:
the one of the characterization parameters is one of transmitted synchronously and received synchronously with the one of the beginning and the end of the overhead information; and
the other of the characterization parameters is one of transmitted synchronously and received synchronously with the one of the beginning and the end of the payload.

12. The apparatus of claim 8, wherein:
the plurality of different types of overhead information comprises data flow control information related to a second data stream different from the first data stream.

13. The apparatus of claim 8, wherein:
the first data stream comprises the two characterization parameters;
the one of the characterization parameters and the one of the start and the end of the overhead information are contiguous with each other in the first data stream; and
the other of the characterization parameters and the one of the start and the end of the payload are contiguous with each other in the first data stream.

14. The apparatus of claim 8, wherein:
the overhead information of the one type includes data transfer control information; and
the circuitry is also capable of inserting in the first data stream additional overhead information of the one type only if at least a portion of the control information changes.

15. An article comprising:
a storage medium having stored thereon instructions that when executed by a machine result in the following:
one of transmitting and receiving a first data stream, the first data stream including payload and overhead information, the payload having a variable size, the overhead information being one type of overhead information selected from a plurality of different types of overhead information, sequence order of the payload and the overhead information being variable if the one type is at least one certain type of overhead information selected from the plurality of different types of overhead information;
one of transmitting and receiving two characterization parameters, one of the characterization parameters indicating, at least, one of a beginning and an end of the overhead information in the first data stream and the one type of the overhead information, the other of the characterization parameters indicating, at least, one of a beginning and an end of the payload in the first data stream.

16. The article of claim 15, wherein the instructions when executed also result in:
one of transmitting and receiving a second data stream that is different from the first data stream, the second data stream comprising the two characterization parameters.

17. The article of claim 16, wherein the instructions when executed also result in:
propagating the first data stream via a first bus; and
propagating the second data stream via a second bus.

18. The article of claim 17, wherein:
the one of the characterization parameters is one of transmitted synchronously and received synchronously with the one of the beginning and the end of the overhead information; and
the other of the characterization parameters is one of transmitted synchronously and received synchronously with the one of the beginning and the end of the payload.

19. The article of claim 15, wherein:
the plurality of different types of overhead information comprises data flow control information related to a second data stream different from the first data stream.

20. The article of claim 15, wherein:
the first data stream comprises the two characterization parameters;
the one of the characterization parameters and the one of the start and the end of the overhead information are contiguous with each other in the first data stream; and
the other of the characterization parameters and the one of the start and the end of the payload are contiguous with each other in the first data stream.

21. The article of claim 15, wherein:
the overhead information of the one type includes data transfer control information; and
the instructions when executed also result in:
inserting in the first data stream additional overhead information of the one type only if at least a portion of the control information changes.

22. A system comprising:
a circuit board including a bus; and
a circuit card capable of being coupled to the bus, the circuit card also including first circuitry capable of transmitting and receiving a plurality of data streams, the plurality of data streams including a first data stream, the first data stream including payload and overhead information, the payload having a variable size, the overhead information being one type of overhead information selected from a plurality of different types of overhead information, sequence order of the payload and the overhead information being variable if the one type is at least one certain type of overhead information selected from the plurality of different types of overhead information, the first circuitry also being capable of transmitting and receiving a plurality of characterization parameters, the plurality of characterization parameters including one characterization parameter indicating, at least, one of a beginning and an end of the overhead information in the first data stream and the one type of the overhead information, the plurality of characterization parameters also including another characterization parameter indicating, at least, one of a beginning and an end of the payload in the first data stream.

23. The system of claim 22, wherein:
the payload comprises a plurality of pairs of data segments, each of the pairs of data segments comprising respective payload data and respective error correction information associated with the respective payload data;
in the first data stream, at least one of the pairs of data segments and at least one other of the pairs of data segments are contiguous with each other; and
in each of the pairs of data segments, the respective payload data and the respective error correction information are contiguous with each other.

24. The system of claim 22, wherein:
the first circuitry includes interface circuitry that is capable of being coupled to a plurality of pairs of buses, the interface circuitry being capable of receiving a plurality of data streams via one of the pairs of buses and also being capable of transmitting a plurality of data streams via another of the pairs of buses.

25. The system of claim 24, further comprising:
a switch coupled to the plurality of pairs of buses.

26. The system of claim 22, wherein:
the circuit card comprises at least one of a data storage controller and a network data communication controller.

27. The system of claim 22, wherein:
the first circuitry is capable of transmitting the first data stream to a mass storage subsystem.

28. The system of claim 22, wherein:
the first circuitry is capable of receiving the first data stream from a mass storage subsystem.

29. The system of claim 22, wherein:
the circuit board comprises a processor that is capable of issuing an input/output request to the first circuitry; and
the first circuitry, in response, at least in part, to receipt of the request, is capable of generating and transmitting the first data stream.
